(19) United States
(12) Patent Application Publication
(10) Pub. No.: US 2004/0222922 A1
(43) Pub. Date: Nov. 11, 2004

(54) Multi-band printed monopole antenna

(76) Inventors: Chia-Ming Kuo, Tu-chen (TW); Lung-Sheng Tai, Tu-Chen (TW); Kuang-Yuan Chang, Tu-chen (TW); Zhen-Da Hung, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/461,015

(22) Filed: Jun. 13, 2003

(30) Foreign Application Priority Data
May 9, 2003 (TW) 92208563

(51) Int. Cl. H01Q 1/38

(52) U.S. Cl. 343/700 MS

(57) ABSTRACT

A multi-band printed monopole antenna (1) includes a substrate (2), a ground portion (5) disposed on a lower surface of the substrate, a first and a second radiating traces (3,4) disposed on an upper surface of the substrate and a feeder cable (6) getting through the substrate. The first radiating trace, the ground trace and the feeder cable form a first monopole antenna operating ate a first frequency band; the second radiating trace, the ground trace and the feeder cable form a second monopole antenna operating at a second monopole antenna.

### BACKGROUND OF THE INVENTION

1. Field of the Invention

The present invention relates to an antenna, and in particular to a multi-band printed monopole antenna employed in a mobile electronic device.

2. Description of the Prior Art

Monopole antennas have been used in wireless communication for long time. Now some designs for handle electronic devices have been attended by monopole antennas. The monopole antennas must be small enough for these devices.

In order to minimize the size of an antenna, printed monopole antennas have been adopted by some engineers. Furthermore, a smaller monopole antenna can be got by introducing a meander radiating trace. U.S. Pat. No. 6,486,834 has disclosed a printed monopole antenna 20 with a meander radiating trace. This antenna 20 is assembled in an electronic device. The antenna 20 comprises a rectangular dielectric substrate 22 with a top and a bottom surfaces respectively on which a meander printed trace 24 and a foil 26 are disposed. A coaxial cable 28 gets through the substrate 22 with its inner conductor 282 soldered onto the trace 24 and its conductive outer shield 284 soldered onto the foil 26. When the antenna 20 is mounted into the electronic device, the foil 26 is connected with the shield of the electronic device to obtain a larger grounding area. However, this antenna 20 only operates in a single frequency band, which is not suitable for devices operated in several communication standards, for example, IEEE802.11a/b.

### BRIEF SUMMARY OF THE INVENTION

A primary object, therefore, of the present invention is to provide a simple multi-band printed monopole antenna for operating in different frequency bands.

A multi-band printed monopole antenna in accordance with the present invention for an electronic device comprises a rectangular dielectric substrate. A meander printed radiating trace and an L-shape printed radiating trace dispose on an upper surface of the substrate and have a common end acting as a feeder point. The L-shape trace is close to the meander trace. The antenna also comprises a ground trace disposed on a lower surface of the substrate and a coaxial cable coupled to these traces. The two radiating traces, the ground trace and the feeder cable respectively form a first and second monopole antennas operating in a lower frequency band and a higher frequency band. The capacitance and inductance between the two radiating traces can be adjusted by the distance between the two radiating traces. Choosing a reasonable distance will make the first monopole antenna have a desired matching impedance.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a top plan view of a preferred embodiment of a multi-band printed monopole antenna in accordance with the present invention.

FIG. 2 is a bottom plan view of the multi-band printed monopole antenna of FIG. 1.

FIG. 3 is a cross-sectional view of the multi-band printed monopole antenna along line III-III of FIG. 1.

FIG. 4 is a top plan view of the multi-band printed monopole antenna of FIG. 1, showing some dimensions of the multi-band printed monopole antenna.

FIG. 5 is a test chart recording for the multi-band printed monopole antenna of FIG. 1, showing Voltage Standing Wave Ratio (VSWR) as a function of frequency.

FIG. 6 is a horizontally polarized principle plane radiation pattern of the multi-band printed monopole antenna of FIG. 1 operating at a frequency of 2.5 GHz.

FIG. 7 is a vertically polarized principle plane radiation pattern of the multi-band printed monopole antenna of FIG. 1 operating at a frequency of 2.5 GHz.

FIG. 8 is a horizontally polarized principle plane radiation pattern of the multi-band printed monopole antenna of FIG. 1 operating at a frequency of 5.35 GHz.

FIG. 9 is a vertically polarized principle plane radiation pattern of the multi-band printed monopole antenna of FIG. 1 operating at a frequency of 5.35 GHz.

FIG. 10 is a horizontally polarized principle plane radiation pattern of the multi-band printed monopole antenna of FIG. 1 operating at a frequency of 5.725 GHz.

FIG. 11 is a vertically polarized principle plane radiation pattern of the multi-band printed monopole antenna of FIG. 1 operating at a frequency of 5.725 GHz.

### DETAILED DESCRIPTION OF THE INVENTION

Reference will now be made in detail to a preferred embodiment of the present invention.

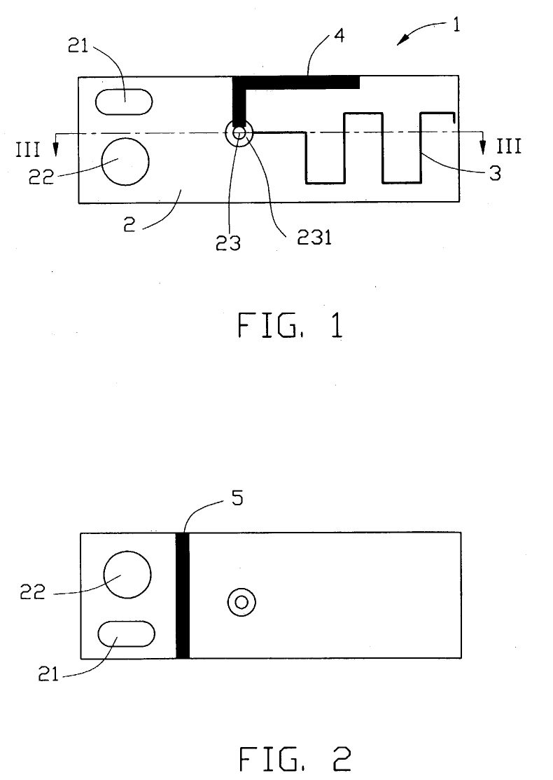

Referring to FIG. 1 and FIG. 2, a multi-band printed monopole antenna 1 in accordance with a preferred embodiment of the present invention comprises an rectangular dielectric substrate 2, a printed meander radiating trace 3, an L-shape printed radiating trace 4, a printed ground trace 5 disposed on the surfaces of the substrate 2 and a feeder cable 6. The antenna also comprises a first and second hole 21, 22 lying in a first short side of the substrate 2 for mounting the antenna into an electronic device and a third hole 23 for feeder cable getting through.

The third hole 23 lies in middle portion of the substrate 2 with a ringed metal patch 231 surrounded on an upper surface of the substrate 2. The patch 231 acts as a feeder point of the multi-band printed monopole antenna 1. The L-shape printed radiating trace 4 and the printed meander radiating trace 3 both extend from the patch 231. The printed meander radiating trace 3 is a rectangular-wave-shape trace and has a free end beside a second short side of the substrate 2. The L-shape printed radiating trace 4 has a long branch along a long side of the substrate 2. There is a predetermined distance between the L-shape printed radiating trace 4 and the printed meander radiating trace 3. A printed ground trace 5 is disposed between the first and second hole 21, 22 and the third hole 23 on the lower surface of the substrate 2. The printed ground trace 5 is parallel to the short sides of the substrate 2 and has a same length with the short sides. When the printed ground trace 5 is mounted to an electronic device, the printed ground trace 5 is electronically connected to a printed circuit board of the electronic device.

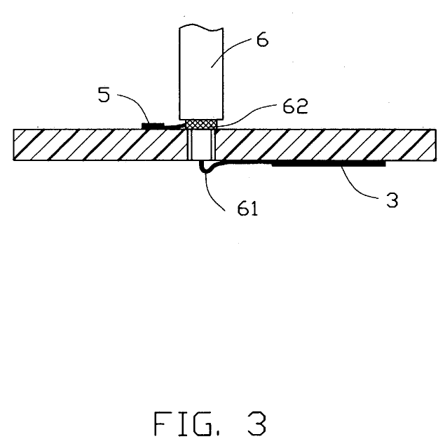

Referring to FIG. 3, a feeder cable 6 is coaxial cable including an inner conductor 61 surrounded by a dielectric layer (not labeled), which is surrounded by a conductive outer shield 62, which is surrounded by an outer jacket (not labeled). A portion of the jacket is stripped off to expose the conductive outer shield 62, and an end portion of the conductive outer shield and the dielectric layer are stripped off to expose a length of the inner conductor 61 The inner conductor 61 gets through the third hole 23 from the lower surface to the upper surface and is soldered onto the patch 231. The conductive outer shield 62 is soldered on to the ground trace 5 on the lower surface of the substrate 2.

The printed meander radiating trace 3, the ground trace 5 and the feeder cable 6 form a first monopole antenna operating in a lower frequency band. The L-shape printed radiating trace 4, the ground trace 5 and the feeder cable 6 form a second monopole antenna operating in a higher frequency band. The distance between the two radiating traces 3, 4 determines the capacitance and inductance therebetween that will influent the parameters of first monopole antenna. Especially, by adjusting the distance, the first monopole can get a desired matching impedance with a real number 50 Ω which matches the impedance of the feeder cable 6.

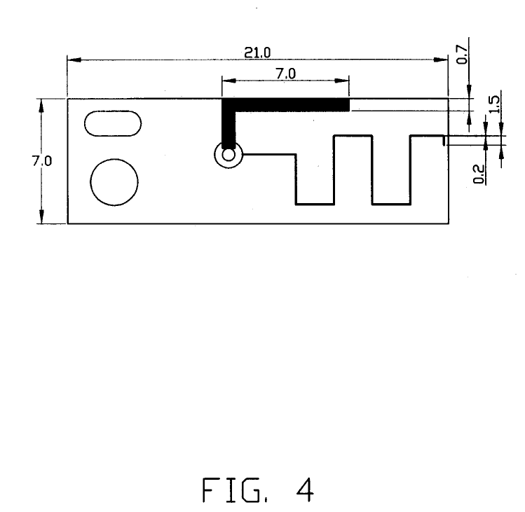

Referring to FIG. 4, major dimensions of the multi-band printed monopole antenna 1 are labeled thereon, wherein all dimensions are in millimeters (mm).

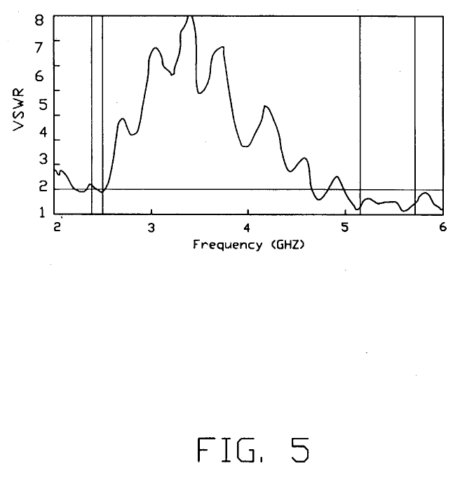

FIG. 5 shows a test chart recording of Voltage Standing Wave Ratio (VSWR) of the multi-band printed monopole antenna 1 as a function of frequency. Note that VSWR drops below the desirable maximum value “2” in the 2.4-2.5 GHz frequency band and in the 5.15-5.725 GHz frequency band, indicating acceptably efficient operation in these two wide frequency bands.

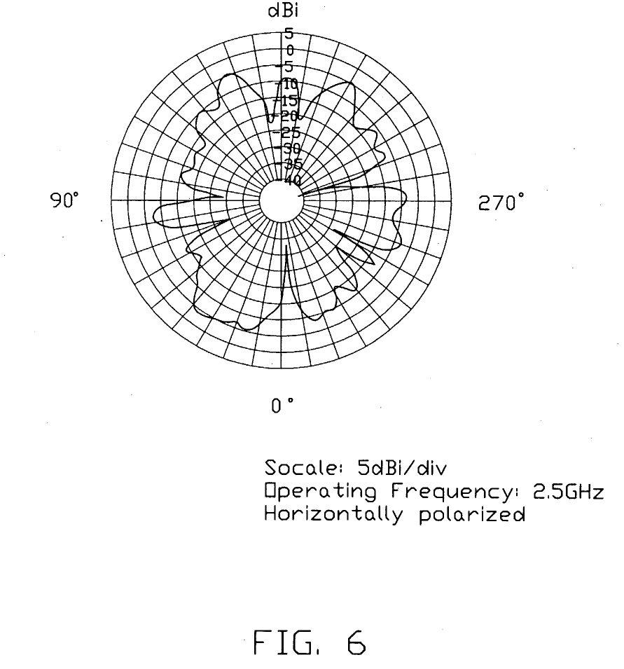

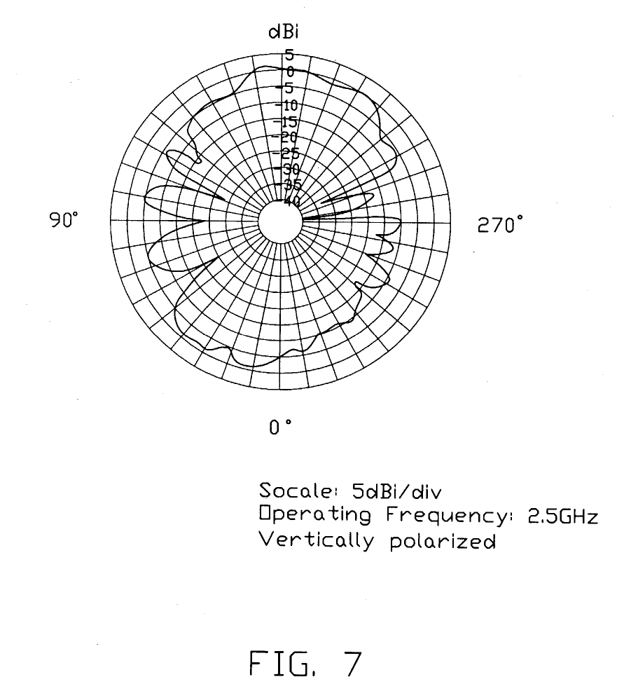

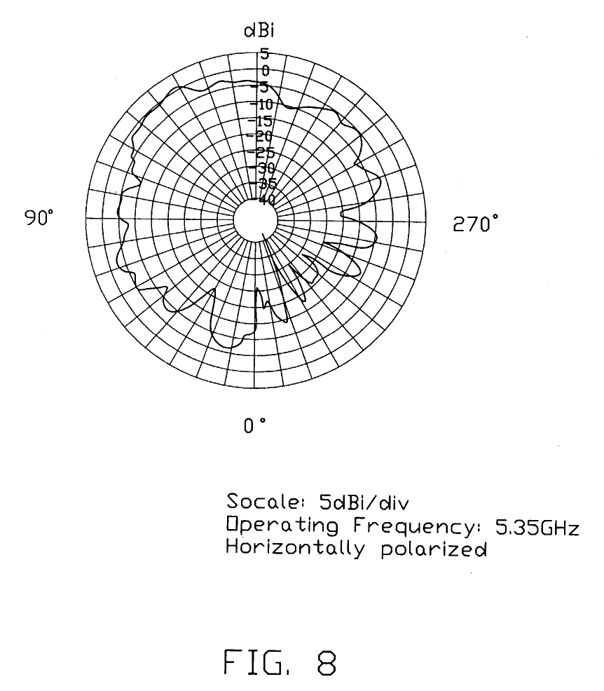

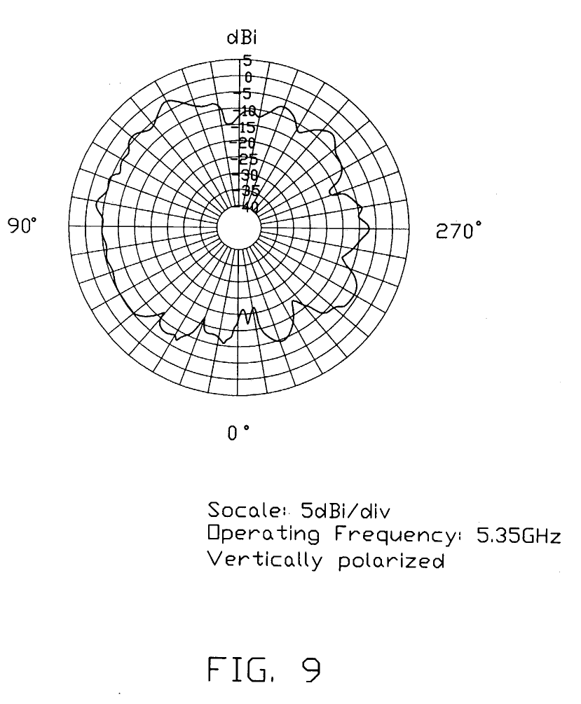

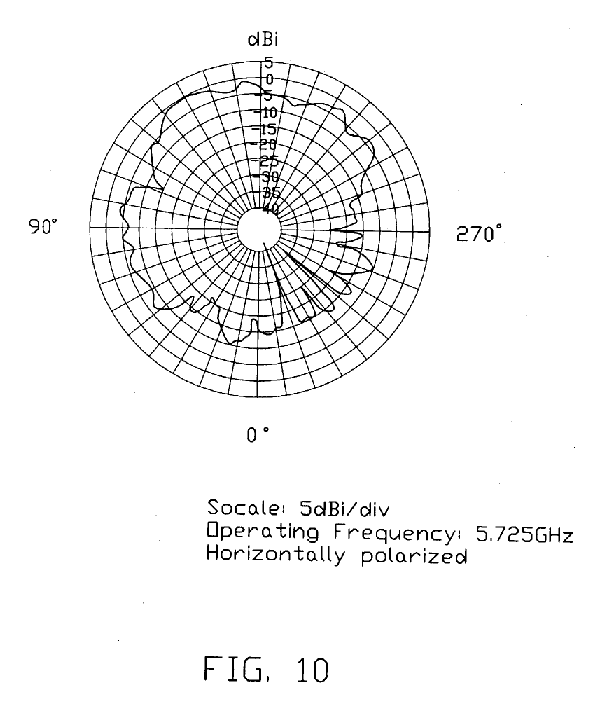

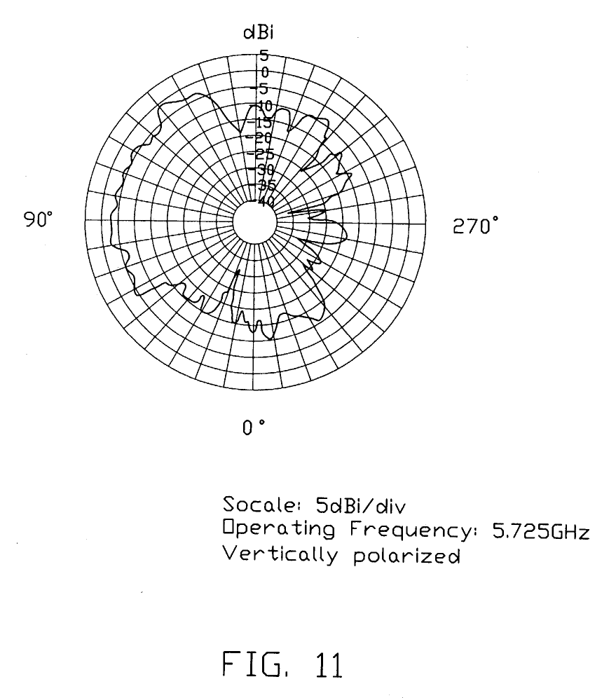

FIGS. 4-9 respectively show horizontally and vertically polarized principle plane radiation patterns of the multi-band printed monopole antenna 1 operating at frequencies of 2.5 GHz, 5.35 GHz, and 5.725 GHz. Note that each radiation pattern is close to a corresponding optimal radiation pattern and there is no obvious radiating blind area.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-band antenna for an electronic device comprising:
a substrate;
a ground trace disposed on a first surface of the substrate;
a first radiating trace and a second radiating trace both disposed on an opposite surface of the substrate; and
a feeder cable comprising an inner conductor connecting with the first and second radiating traces and a conductive outer shield connecting with the ground trace;
wherein the first radiating trace, the ground trace and the feeder cable form a first monopole antenna operating at a first frequency band; the second radiating trace, the ground trace and the feeder cable form a second monopole antenna operating at a second frequency band.

2. The multi-band antenna as claimed in claim 1, wherein the first radiating trace is a meander printed trace with a rectangular wave shape.

3. The multi-band antenna as claimed in claim 2, wherein the first and second radiating traces have a common end.

4. The multi-band antenna as claimed in claim 3, wherein the second radiating trace is an L-shape printed trace.

5. The multi-band antenna as claimed in claim 4, wherein the inner conductor is soldered to the common end, and wherein the conductive outer shield is soldered to the ground trace on the first surface of the substrate.

6. A multi-band antenna for an electronic device operated in a first and second frequency bands comprising:
a substrate;
a ground portion disposed on the substrate;
a first and a second monopole antenna having a common feeder point disposed on a first surface substrate;
a feed cable having an inner conductor getting through from a second surface to the first surface to solder onto the common feeder point and a conductive outer shield solder onto the ground portion.

7. The multi-band antenna as claimed in claim 6, wherein the first monopole antenna comprises a meander printed radiating trace extending from the common feeder point.

8. The multi-band antenna as claimed in claim 7, wherein the second monopole antenna comprises an L-shape printed radiating trace extending from the common feeder point.

9. A multi-band antenna comprising:
a substrate defining two opposite first and second surfaces;
a ground trace formed on the first surface;
a first radiating trace defining mainly a straight section, and a meandering second radiating trace both extending on the second surface; and
a feeder cable extending through a through hole the substrate from the first surface to the second surface with an inner conductor connected to the both said first and second radiating traces and an outer conductor connected to the ground trace; wherein
said first radiating trace is wider but shorter than the second radiating trace.

10. The antenna as claimed in claim 9, wherein said second trace extends around a middle portion of the substrate while the straight section of the first trace extends essentially along an edge portion of the substrate.

11. The antenna as claimed in claim 9, wherein the substrate further includes another through hole, and the ground trace is located between said two through holes.

12. The antenna as claimed in claim 9, wherein said first trace and said second trace are discrete from each other while meet around said feeder cable.
